(19) United States
(12) Patent Application Publication
(10) Pub. No.: US 2026/0160194 A1
(43) Pub. Date: Jun. 11, 2026

(54) ENGINE CATALYST DIAGNOSIS APPARATUS

(71) Applicant: Mazda Motor Corporation, Hiroshima (JP)

(72) Inventors: Takumi Asada, Aki-gun (JP); Yuji Sakata, Aki-gun (JP); Jin Maruyama, Aki-gun (JP)

(21) Appl. No.: 19/395,233

(22) Filed: Nov. 20, 2025

(30) Foreign Application Priority Data
Dec. 9, 2024 (JP) 2024-214185

(51) Int. Cl. F01N 11/00; F02D 41/02; F02D 41/38; G01M 15/10; G07C 5/08

(52) U.S. Cl. CPC F01N 11/002; F02D 41/0235; F02D 41/38; G01M 15/102; G07C 5/0808; G07C 5/0825; F01N 2550/02; F01N 2550/03

(57) ABSTRACT

An engine catalyst diagnosis apparatus includes an exhaust passage for discharging exhaust gas from a combustion chamber of an engine, a catalyst device provided on the exhaust passage for purifying the exhaust gas, a linear A/F sensor that is provided on the exhaust passage downstream of the catalyst device and is configured to detect the air-fuel ratio of the exhaust gas, and a processing device configured to diagnose the catalyst device on the basis of the air-fuel ratio detected by the linear A/F sensor, and at start of the engine after soaking, the processing device acquires the temperature of the catalyst device, calculates a fluctuation range of the air-fuel ratio detected by the linear A/F sensor within a predetermined time, and diagnoses the catalyst device on the basis of a relationship between the fluctuation range and the catalyst temperature.

### TECHNICAL FIELD

The present disclosure relates to an engine catalyst diagnosis apparatus that performs diagnosis of a catalyst device that purifies exhaust gas of an engine.

### BACKGROUND ART

On an exhaust passage of an engine, a catalyst device for purifying exhaust gas is conventionally provided, and diagnosis (deterioration diagnosis) is performed for the catalyst device on the basis of an air-fuel ratio of the exhaust gas and the like. For example, JP2013-83195A describes a technique in which oxygen sensors are provided on the upstream side and the downstream side of the catalyst device, and the standard dispersion of oxygen concentration fluctuation values in exhaust gas is compared between the upstream side and the downstream side of the catalyst device, thereby determining deterioration of the catalyst device.

### SUMMARY

### Problems to be Solved

In recent years, exhaust emission regulations for vehicles have become extremely stringent, and thus more accurate diagnosis of catalyst devices is required. In response to such a demand, the inventors of the present disclosure have conducted intensive studies. As a result, the inventors of the present disclosure have discovered that it is possible to more accurately diagnose the catalyst device at start of the engine after soaking, that is, in cold condition (at cold start).

In cold condition, the catalyst device gradually becomes active as the temperature increases, that is, the exhaust gas purification performance (purification rate) gradually rises (this is referred to as the light-off performance of the catalyst device). At this time, the rise tends to be rapid when the catalyst device is normal, but slow when the catalyst device is deteriorated. Thus, it can be said that in cold condition, the difference corresponding to the degree of deterioration of the catalyst device becomes noticeable. Therefore, the inventors of the present disclosure have considered diagnosing the catalyst device in cold condition.

The inventors of the present disclosure have also considered using air-fuel ratio of the exhaust gas on the downstream side of the catalyst device in determination of the active state of the catalyst device. This is because although the air-fuel ratio on the downstream side of the catalyst device fluctuates relatively largely when the catalyst device is not active, as the catalyst device becomes active, the consumption of oxygen in the catalyst device increases (because the oxygen reduction efficiency of the catalyst device with respect to the exhaust gas increases), which reduces fluctuation of the air-fuel ratio on the downstream side of the catalyst device. Thus, it can be said that the active state of the catalyst device can be appropriately determined on the basis of the fluctuation of the air-fuel ratio of the exhaust gas on the downstream side of the catalyst device.

Furthermore, the inventors of the present disclosure have considered detecting the air-fuel ratio of the exhaust gas on the downstream side of the catalyst device using a linear air-fuel (A/F) sensor. This is because a linear A/F sensor can accurately detect the air-fuel ratio. Specifically, since a linear A/F sensor outputs a signal (voltage or current signal) corresponding to the magnitude of the air-fuel ratio, the detection range for the air-fuel ratio is wide. In contrast, a lambda O₂ sensor basically can only detect the air-fuel ratio close to the stoichiometric air-fuel ratio, that is, can only detect whether the air-fuel ratio of the exhaust gas deviates from the stoichiometric air-fuel ratio. Thus, a lambda O₂ sensor has a far narrower detection range for the air-fuel ratio than a linear A/F sensor.

The present disclosure has been made on the basis of the findings as described above, and an object thereof is to significantly improve the diagnostic accuracy of the catalyst device in an engine catalyst diagnosis apparatus that performs diagnosis of a catalyst device that purifies exhaust gas of an engine.

### Solution to Problems

In order to achieve the object described above, the present disclosure provides an engine catalyst diagnosis apparatus, including an exhaust passage for discharging exhaust gas from a combustion chamber of the engine, a catalyst device provided on the exhaust passage for purifying the exhaust gas, a linear A/F sensor that is provided on the exhaust passage downstream of the catalyst device and is configured to detect an air-fuel ratio of the exhaust gas, and a processing device configured to diagnose the catalyst device on the basis of the air-fuel ratio detected by the linear A/F sensor, wherein the processing device is configured to, at start of the engine after soaking, acquire a temperature of the catalyst device, calculate a fluctuation range of the air-fuel ratio detected by the linear A/F sensor within a predetermined time, and diagnose the catalyst device on the basis of a relationship between the fluctuation range and the temperature of the catalyst device.

In the present disclosure configured in this manner, at start after soaking (i.e., in cold condition) in which the difference corresponding to the degree of deterioration of the catalyst device becomes noticeable, the processing device diagnoses the catalyst device. In particular, since the temperature (catalyst temperature) at which the catalyst device becomes active changes in accordance with the degree of deterioration of the catalyst device, the processing device uses the catalyst temperature to diagnose the catalyst device. In addition, the processing device uses the fluctuations of the air-fuel ratio on the downstream side of the catalyst device to determine the active state of the catalyst device. This is because although the air-fuel ratio on the downstream side of the catalyst device fluctuates relatively largely when the catalyst device is not active, as the catalyst device becomes active, the consumption of oxygen in the catalyst device increases, which reduces fluctuation of the air-fuel ratio on the downstream side of the catalyst device, and thus the active state of the catalyst device can be appropriately determined on the basis of such fluctuation (in particular, the fluctuation range) of the air-fuel ratio. From the above, in the present disclosure, when in cold condition, the processing device diagnoses the catalyst device on the basis of the relationship between the fluctuation range of the air-fuel ratio on the downstream side of the catalyst device and the catalyst temperature. This makes it possible to significantly improve the diagnostic accuracy of the catalyst device.

In the present disclosure, preferably, the processing device is configured to determine a degree of activity of the catalyst device on the basis of the fluctuation range, and acquire the temperature of the catalyst device when the catalyst device reaches a predetermined degree of activity on the basis of a result of determining the degree of activity, and diagnose the catalyst device on the basis of the temperature.

In the present disclosure configured in this manner, by using the catalyst temperature when the catalyst device reaches the predetermined degree of activity, it is possible to appropriately diagnose the catalyst device.

In the present disclosure, preferably, the processing device diagnoses deterioration of the catalyst device when the temperature of the catalyst device, when the catalyst device reaches the predetermined degree of activity, is equal to or higher than a predetermined temperature.

In this case, since the rise of the exhaust gas purification performance of the catalyst device is slow, the processing device diagnoses the deterioration of the catalyst. This makes it possible to appropriately diagnose the catalyst device.

In the present disclosure, preferably, the engine catalyst diagnosis apparatus further includes, when the linear A/F sensor is defined as a second linear A/F sensor, the air-fuel ratio detected by the second linear A/F sensor is defined as a second air-fuel ratio, and the fluctuation range of the second air-fuel ratio detected by the second linear A/F sensor within the predetermined time is defined as a second fluctuation range, a first linear A/F sensor that is provided on the exhaust passage upstream of the catalyst device and is configured to detect a first air-fuel ratio of the exhaust gas, and the processing device is configured to, at start in the engine after soaking, calculate a first fluctuation range of the first air-fuel ratio detected by the first linear A/F sensor within the predetermined time together with the second fluctuation range, calculate a fluctuation range ratio that is a ratio of the first fluctuation range to the second fluctuation range, and determine the degree of activity of the catalyst device on the basis of the fluctuation range ratio.

Since the first fluctuation range on the upstream side of the catalyst device is not affected by the exhaust gas purification performance of the catalyst device and thus stable, in the present disclosure, the magnitude of the second fluctuation range on the downstream side of the catalyst device is evaluated using such a first fluctuation range as a criterion (reference). This makes it possible to ensure the diagnostic accuracy of the catalyst device.

In the present disclosure, preferably, the processing device normalizes the fluctuation range ratio, determines that the catalyst device has reached the predetermined degree of activity when the normalized fluctuation range ratio reaches a predetermined value, and diagnoses the catalyst device on the basis of the temperature of the catalyst device at this time.

Since the fluctuation range ratio has no unit and changes in accordance with various factors such as the amount of precious metal, the durability, and the deteriorated state of the catalyst device, in order to eliminate the influence of these factors and ensure versatility, the process is performed using the value obtained by normalizing the fluctuation range ratio. This makes it possible to effectively ensure the diagnostic accuracy of the catalyst device.

In the present disclosure, preferably, the engine catalyst diagnosis apparatus further includes, when the linear A/F sensor is defined as a second linear A/F sensor and the air-fuel ratio detected by the second linear A/F sensor is defined as a second air-fuel ratio, a first linear A/F sensor that is provided on the exhaust passage upstream of the catalyst device and is configured to detect a first air-fuel ratio of the exhaust gas, and the processing device is configured to, when a fuel cut for the engine is being executed after start of the engine, calculate an oxygen storage capacity (OSC) of the catalyst device on the basis of the first air-fuel ratio detected by the first linear A/F sensor and the second air-fuel ratio detected by the second linear A/F sensor, and further diagnose the catalyst device on the basis of the oxygen storage capacity.

During the fuel cut for the engine, since basically only air is supplied to the catalyst device, the catalyst device tends to assume an oxygen-saturated state. According to the present disclosure described above, by diagnosing the catalyst device on the basis of the oxygen storage capacity in such an oxygen-saturated state, it is possible to accurately diagnose the catalyst device.

In the present disclosure, preferably, the engine catalyst diagnosis apparatus further includes a fuel injection valve for supplying fuel to the combustion chamber, and the processing device is configured to control the fuel injection valve so as to increase an amount of fuel supplied to the combustion chamber when the engine returns from the fuel cut, and make an amount by which the amount of fuel is increased smaller when deterioration of the catalyst device is diagnosed than when it is not diagnosed.

According to the present disclosure configured in this manner, it is possible to reduce an unnecessary increase in the amount of fuel and improve fuel efficiency.

In the present disclosure, preferably, the engine catalyst diagnosis apparatus further includes a warning light for notifying an occupant of the vehicle of an abnormality, and the processing device is configured to perform control to turn on the warning light when it is diagnosed that the catalyst device is deteriorated.

According to the present disclosure configured in this manner, it is possible to appropriately notify the occupant of the deterioration of the catalyst device and urge the occupant, for example, to replace the catalyst device.

### Advantageous Effect

According to the present disclosure, in the engine catalyst diagnosis apparatus that performs diagnosis of the catalyst device that purifies exhaust gas of the engine, it is possible to significantly improve the diagnostic accuracy of the catalyst device.

### BRIEF DESCRIPTION OF DRAWINGS

FIG. 1 is a schematic configuration diagram of an engine catalyst diagnosis apparatus according to an embodiment of the present disclosure.

FIG. 2 is a block diagram showing an electrical configuration of the engine catalyst diagnosis apparatus according to the embodiment of the present disclosure.

FIG. 3 is an explanatory diagram of a catalyst temperature that is acquired in accordance with a normalized fluctuation range ratio in the embodiment of the present disclosure.

FIG. 4 is an explanatory diagram of deterioration determination based on the catalyst temperature acquired in FIG. 3 in the embodiment of the present disclosure.

FIG. 5 is a flowchart showing a catalyst diagnosis process that is performed in cold condition in the embodiment of the present disclosure.

FIG. 6 is a time chart showing the catalyst diagnosis process that is performed in cold condition in the embodiment of the present disclosure.

FIG. 7 is a flowchart showing a catalyst diagnosis process that is performed in warm condition in the embodiment of the present disclosure.

### DETAILED DESCRIPTION

An engine catalyst diagnosis apparatus according to an embodiment of the present disclosure will be described below with reference to the accompanying drawings.

### Apparatus Configuration

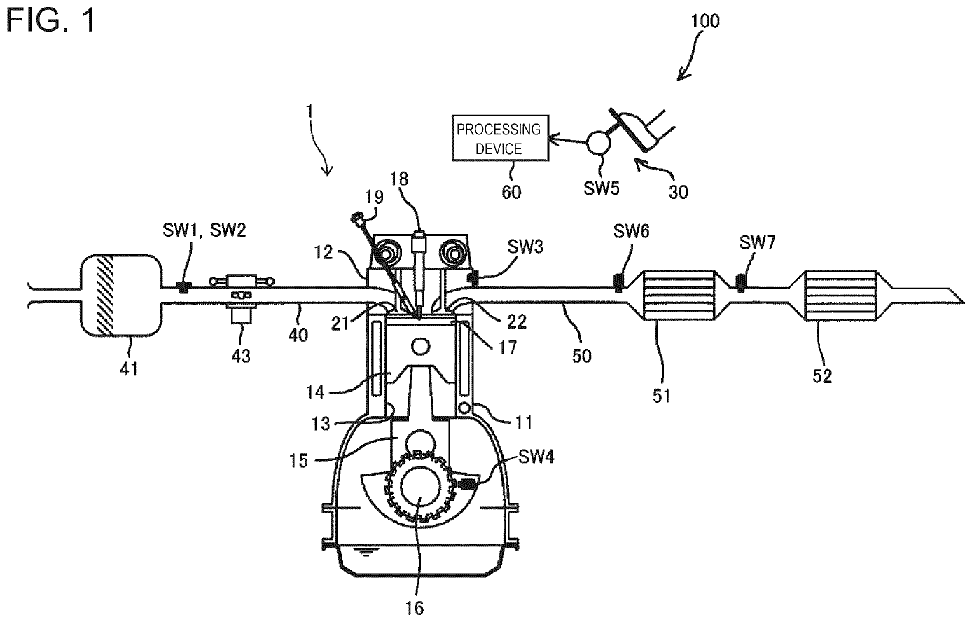

First, the entire configuration of the engine catalyst diagnosis apparatus according to the present embodiment will be described with reference to FIG. 1. FIG. 1 is a schematic configuration diagram of the engine catalyst diagnosis apparatus according to the present embodiment.

An engine catalyst diagnosis apparatus 100 is mounted on a vehicle (not shown) and, as shown in FIG. 1, mainly includes an engine 1 as an internal combustion engine that generates motive power (driving force) of the vehicle, an intake passage 40 that supplies air (intake air) to the engine 1, and an exhaust passage 50 that discharges exhaust gas from the engine 1.

The engine 1 is a four-stroke engine that performs an intake stroke, a compression stroke, an expansion stroke, and an exhaust stroke. The engine 1 is a gasoline engine that uses gasoline as fuel. This fuel may be any liquid fuel that contains at least gasoline, and may be, for example, gasoline containing bioethanol or the like.

Specifically, the engine 1 mainly includes a cylinder block 11, a cylinder head 12 that is provided on the cylinder block 11 and forms a cylinder 13 together with the cylinder block 11, a piston 14 that reciprocates inside the cylinder 13, a connecting rod 15 coupled to the piston 14, and a crankshaft 16 coupled to the connecting rod 15. The engine 1 is, for example, a multi-cylinder engine including a plurality of cylinders 13 (only one cylinder 13 is shown in FIG. 1). The cylinder block 11, the cylinder head 12, and the piston 14 form a combustion chamber 17 of the engine 1.

In addition, the engine 1 includes a fuel injection valve 18 and a spark plug 19 each of which is provided on the cylinder head 12. The fuel injection valve 18 injects fuel into the cylinder 13 (into the combustion chamber 17), and the spark plug 19 ignites air-fuel mixture of fuel and air inside the cylinder 13. A fuel supply system (not shown) is connected to the fuel injection valve 18, and fuel is supplied to the fuel injection valve 18 from the system. Note that although in the engine 1 shown in FIG. 1, the fuel injection valve 18 that is disposed so as to inject fuel from above the combustion chamber 17 is shown, the fuel injection valve 18 may be disposed so as to inject fuel from the side of the combustion chamber 17. In the latter case, the fuel injection valve 18 may be provided on the cylinder block 11.

On the other hand, the intake passage 40 is provided with an air cleaner 41 and a throttle valve 43. The throttle valve 43 adjusts the amount of air introduced into the cylinder 13 in accordance with its opening degree. In addition, an intake valve 21 is provided between the intake passage 40 and the cylinder 13. The intake valve 21 is opened and closed at predetermined timings by a valvetrain. Typically, the valvetrain is an electric or hydraulic variable valvetrain that varies valve timing and/or valve lift. For example, the valvetrain is an intake sequential-valve timing (S-VT) that can continuously change the rotational phase of an intake camshaft relative to the crankshaft 16 within a predetermined angle range.

Next, the exhaust passage 50 is provided with an exhaust valve 22. Specifically, the exhaust valve 22 is provided between the cylinder 13 and the exhaust passage 50. The exhaust valve 22 is opened and closed at predetermined timings by a valvetrain. Typically, the valvetrain is an electric or hydraulic variable valvetrain that varies valve timing and/or valve lift. For example, the valvetrain is an exhaust S-VT that continuously changes the rotational phase of an exhaust camshaft relative to the crankshaft 16 within a predetermined angle range.

In addition, the exhaust passage 50 is provided with two catalyst devices (catalyst converters) 51, 52 each of which includes a three-way catalyst. The catalyst device 51 is provided upstream of the catalyst device 52, and the catalyst device 52 is provided downstream of the catalyst device 51. The three-way catalyst contains platinum group metals (PGM) such as platinum (Pt), palladium (Pd), and rhodium (Rh), and purifies HC, CO, NOₓ, and the like in the exhaust gas. Basically, the three-way catalyst purifies (oxidizes) HC, CO when the air-fuel ratio of the exhaust gas is close to the stoichiometric air-fuel ratio and higher (leaner) than the stoichiometric air-fuel ratio, and purifies (reduces) NOₓ when the air-fuel ratio of the exhaust gas is close to the stoichiometric air-fuel ratio and lower (richer) than the stoichiometric air-fuel ratio. Note that use of two catalyst devices 51, 52 is not limiting but it is only required that at least the catalyst device 51 be used, and the catalyst device 52 does not have to be provided on the downstream side of the catalyst device 51.

In addition, as shown in FIG. 1, the engine catalyst diagnosis apparatus 100 includes an air flow sensor SW1, an intake air temperature sensor SW2, a water temperature sensor SW3, a crank angle sensor SW4, an accelerator opening degree sensor SW5, and linear air-fuel (A/F) sensors SW6, SW7.

The air flow sensor SW1 is provided on the intake passage 40 on the downstream side of the air cleaner 41 and detects the flow rate of air flowing through the intake passage 40. The intake air temperature sensor SW2 is provided on the intake passage 40 on the downstream side of the air cleaner 41 and detects the temperature of air flowing through the intake passage 40. The water temperature sensor SW3 is provided on the engine 1 and detects the temperature of a coolant in the engine 1. The crank angle sensor SW4 is provided on the engine 1 and detects the rotational angle of the crankshaft 16. The accelerator opening degree sensor SW5 is provided on an accelerator pedal mechanism 30 and detects an accelerator opening degree corresponding to the operation amount of an accelerator pedal. The linear A/F sensor SW6 is provided on the exhaust passage 50 upstream of the catalyst device 51 and detects the air-fuel ratio of the exhaust gas flowing into the catalyst device 51 (hereinbelow, referred to as the “first detected air-fuel ratio” as appropriate). The linear A/F sensor SW7 is provided on the exhaust passage 50 downstream of the catalyst device 51 and detects the air-fuel ratio of the exhaust gas flowing out of the catalyst device 51 (hereinbelow, referred to as the “second detected air-fuel ratio” as appropriate). The linear A/F sensors SW6, SW7 output a signal (voltage or current signal) corresponding to the magnitude of the air-fuel ratio.

Note that the linear A/F sensors SW6, SW7 are examples of a “first linear A/F sensor” and a “second linear A/F sensor” in the present disclosure, respectively, and the first and second detected air-fuel ratios are examples of a “first air-fuel ratio” and a “second air-fuel ratio” in the present disclosure, respectively.

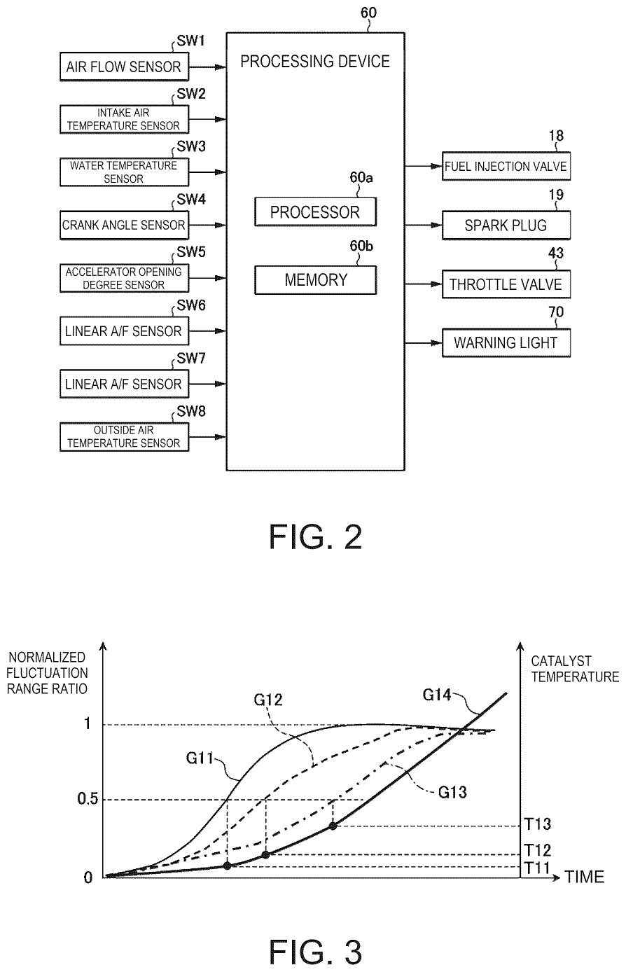

Next, the electrical configuration of the engine catalyst diagnosis apparatus 100 according to the present embodiment will be described with reference to FIG. 2. FIG. 2 is a block diagram showing the electrical configuration of the engine catalyst diagnosis apparatus 100 according to the present embodiment.

As shown in FIG. 2, the engine catalyst diagnosis apparatus 100 includes a processing device 60 configured to perform various controls and processes in the apparatus 100. The processing device 60 is composed of a circuit and is a control device based on a well-known microcomputer. The processing device 60 includes one or more processors 60a as a central processing unit (CPU) that executes programs, a memory 60b that is composed of, for example, a random access memory (RAM) or a read only memory (ROM) and stores programs and data, an input/output bus that inputs and outputs electric signals, and the like. For example, the processing device 60 is an electronic control unit (ECU).

Detection signals (output signals) from an outside air temperature sensor SW8 that detects an outside air temperature in addition to the sensors SW1 to SW7 described above are input to the processing device 60. Then, the processing device 60 controls the fuel injection valve 18, the spark plug 19, the throttle valve 43, and the like of the engine 1 on the basis of these detection signals. In addition, the processing device 60 also controls a warning light 70 for notifying an occupant of the vehicle of an abnormality. In particular, in the present embodiment, the processing device 60 diagnoses the catalyst device 51 on the basis of the air-fuel ratios detected by the linear A/F sensors SW6, SW7, and performs control corresponding to a result of the diagnosis (hereinbelow, such a control process is referred to as a “catalyst diagnosis process”).

### Catalyst Diagnosis Process

Next, the catalyst diagnosis process performed by the processing device 60 in the present embodiment will be described.

### (Process in Cold Condition)

First, the catalyst diagnosis process that is performed at start in the engine 1 after soaking, that is, in cold condition (assuming that the catalyst device 51 is not in an active state) in the present embodiment will be described.

As described above, the inventors of the present disclosure have discovered that the catalyst device 51 can be more accurately diagnosed in cold condition (at cold start) of the engine 1. The reason for this is as follows. In cold condition, the catalyst device 51 gradually becomes active as the temperature increases, that is, the exhaust gas purification performance (purification rate) gradually rises (light-off performance). At this time, the rise tends to be rapid when the catalyst device 51 is normal, but slow when the catalyst device 51 is deteriorated. This is because when the catalyst device 51 is deteriorated, the precious metal condenses on the catalyst surface due to thermal stress, which reduces the active surface and degrades the exhaust gas purification performance. Thus, it can be said that, in cold condition, the difference corresponding to the degree of deterioration of the catalyst device 51 becomes noticeable.

In particular, the temperature at which the catalyst device 51 becomes active changes in accordance with the degree of deterioration of the catalyst device 51. Specifically, when the catalyst device 51 is normal, the catalyst device 51 becomes active at a relatively low temperature (thereby accelerating the rise of the exhaust gas purification performance), whereas when the catalyst device 51 is deteriorated, the catalyst device 51 does not become active until the catalyst device 51 reaches a relatively high temperature (thereby decelerating the rise of the exhaust gas purification performance). Thus, the inventors of the present disclosure have considered diagnosing the catalyst device 51 on the basis of the catalyst temperature when the catalyst device 51 reaches a predetermined degree of activity in cold condition.

In addition, the inventors of the present disclosure have considered using the air-fuel ratio of the exhaust gas on the downstream side of the catalyst device 51 in determination of the degree of activity of the catalyst device 51. This is because although the air-fuel ratio on the downstream side of the catalyst device 51 fluctuates relatively largely when the catalyst device 51 is not active, as the catalyst device 51 becomes active, the consumption of oxygen in the catalyst device 51 increases (because the oxygen reduction efficiency of the catalyst device 51 with respect to the exhaust gas increases), which reduces fluctuations of the air-fuel ratio on the downstream side of the catalyst device 51. Thus, it can be said that the degree of activity of the catalyst device 51 can be appropriately determined on the basis of the fluctuations of the air-fuel ratio of the exhaust gas on the downstream side of the catalyst device 51.

From the above, in the present embodiment, in cold condition of the engine 1, the processing device 60 acquires the temperature of the catalyst device 51 and calculates a fluctuation range of the second detected air-fuel ratio detected by the linear A/F sensor SW7 within a predetermined time, and diagnoses the catalyst device 51 on the basis of the relationship between the fluctuation range and the catalyst temperature. Specifically, the processing device 60 determines the degree of activity of the catalyst device 51 on the basis of the fluctuation range of the second detected air-fuel ratio, and diagnoses the catalyst device 51 on the basis of the catalyst temperature when the catalyst device 51 reaches the predetermined degree of activity. When the acquired catalyst temperature is equal to or higher than a predetermined temperature, the processing device 60 diagnoses deterioration of the catalyst device 51. This is because it can be said that the rise of the exhaust gas purification performance of the catalyst device 51 is slow in this case.

In addition, in the present embodiment, the processing device 60 not only calculates the fluctuation range of the second detected air-fuel ratio detected within the predetermined time by the linear A/F sensor SW7 provided on the downstream side of the catalyst device 51 (second fluctuation range) but also calculates the fluctuation range of the first detected air-fuel ratio detected within the predetermined time by the linear A/F sensor SW6 provided on the upstream side of the catalyst device 51 (first fluctuation range), calculates a fluctuation range ratio that is the ratio of the first fluctuation range to the second fluctuation range, and determines the degree of activity of the catalyst device 51 on the basis of the fluctuation range ratio. Since the first fluctuation range on the upstream side of the catalyst device 51 is not affected by the exhaust gas purification performance of the catalyst device 51 and thus stable, in the present embodiment, the magnitude of the second fluctuation range on the downstream side of the catalyst device 51 is evaluated using such a first fluctuation range as a criterion (reference).

In particular, in the present embodiment, the processing device 60 normalizes the fluctuation range ratio described above, determines that the catalyst device 51 has reached the predetermined degree of activity when the fluctuation range ratio normalized (hereinbelow, referred to as the “normalized fluctuation range ratio” as appropriate) reaches a predetermined value, and diagnoses the catalyst device 51 on the basis of the catalyst temperature at this time. Since the fluctuation range ratio has no unit and changes in accordance with various factors such as the amount of precious metal, the durability, and the deteriorated state of the catalyst device 51, to eliminate the influence of these factors and ensure versatility, the process is performed using the value obtained by normalizing the fluctuation range ratio (the normalized fluctuation range ratio).

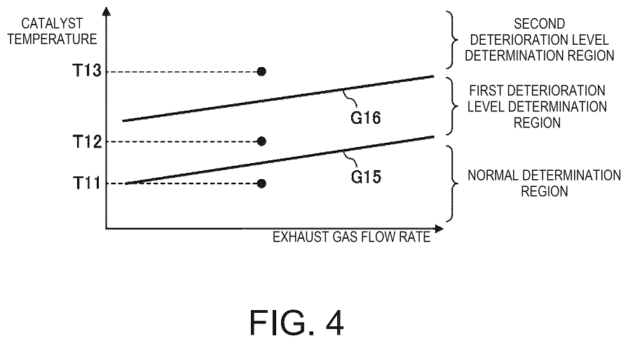

Here, the catalyst diagnosis process performed in cold condition in the present embodiment will be specifically described with reference to FIGS. 3 and 4. FIG. 3 is an explanatory diagram of the catalyst temperature that is acquired in accordance with the normalized fluctuation range ratio in the present embodiment, and FIG. 4 is an explanatory diagram of the deterioration determination based on the catalyst temperature acquired in FIG. 3.

FIG. 3 shows time on the horizontal axis, and shows the normalized fluctuation range ratio and the catalyst temperature on the vertical axis. Specifically, graph G11 shows an example of a temporal change in the normalized fluctuation range ratio when the catalyst device 51 is normal, graph G12 shows an example of a temporal change in the normalized fluctuation range ratio when the catalyst device 51 is at a deterioration level that does not require replacement (hereinbelow, referred to as the “first deterioration level”), and graph G13 shows an example of a temporal change in the normalized fluctuation range ratio when the catalyst device 51 is at a deterioration level that requires replacement (corresponding to a failure, hereinbelow, referred to as the “second deterioration level”). The normalized fluctuation range ratio is expressed in the range of 0 to 1 by performing a normalization process with a maximum value of the fluctuation range ratio obtained in a series of processes (corresponding to the value when the temporal change in the fluctuation range ratio becomes extremely small) defined as 1. In addition, graph G14 shows an example of a temporal change in the catalyst temperature. For example, this catalyst temperature is the temperature estimated by the processing device 60.

From graphs G11, G12, G13, it can be seen that the rise of the normalized fluctuation range ratio is slower when the catalyst device 51 is deteriorated than when the catalyst device 51 is normal. This means that the rise of the exhaust gas purification performance of the catalyst device 51 is slow, in other words, the speed with which the catalyst device 51 becomes active is slow. The processing device 60 acquires the catalyst temperature when the normalized fluctuation range ratio reaches the predetermined value using the temporal change in the catalyst temperature shown in graph G14. For example, the processing device 60 acquires temperatures T11, T12, T13 as the catalyst temperatures when the normalized fluctuation range ratio reaches the predetermined value (0.5) in graphs G11, G12, and G13, respectively. When the catalyst temperature to be acquired is higher when the catalyst device 51 is deteriorated than when the catalyst device 51 is normal (T13>T12>T11).

Next, FIG. 4 shows an exhaust gas flow rate on the horizontal axis and shows the catalyst temperature on the vertical axis. Specifically, graph G15 is a determination line that is defined by the exhaust gas flow rate and the catalyst temperature and distinguishes between being normal and the first deterioration level of the catalyst device 51, and graph G16 is a determination line that is defined by the exhaust gas flow rate and the catalyst temperature and distinguishes between the first deterioration level and the second deterioration level of the catalyst device 51. For example, when the catalyst temperature T11 is acquired, since T11 is below the determination line G15, the processing device 60 determines that the catalyst device 51 is normal, when the catalyst temperature T12 is acquired, since T12 is above the determination line G15 and below the determination line G16, the processing device 60 determines that the catalyst device 51 is at the first deterioration level, and when the catalyst temperature T13 is acquired, since T13 is above the determination line G16, the processing device 60 determines that the catalyst device 51 is at the second deterioration level.

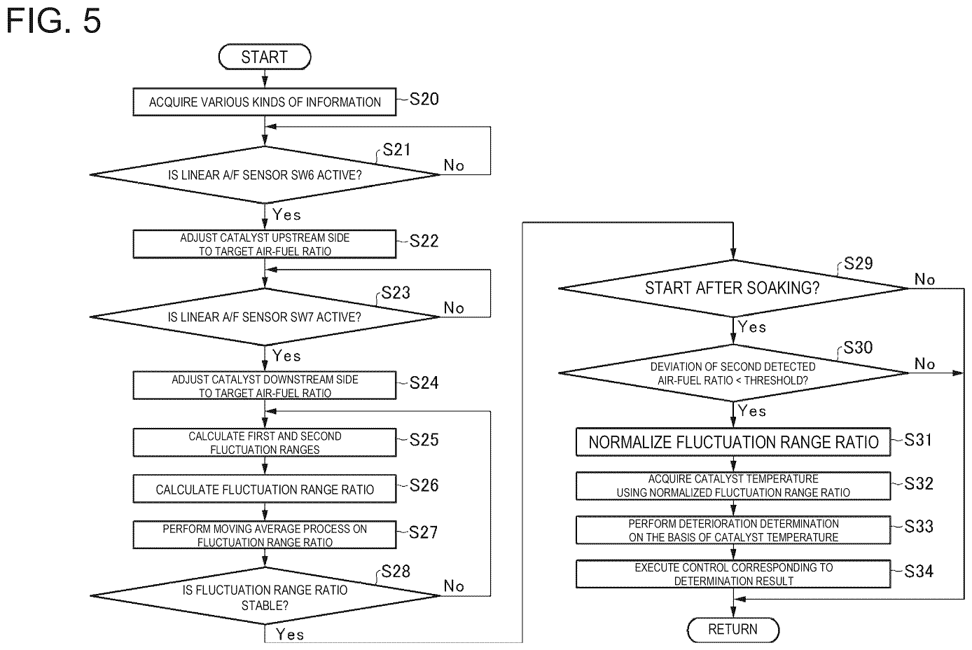

Next, a flowchart showing the catalyst diagnosis process performed in cold condition in the present embodiment will be described with reference to FIG. 5. This flow is repeatedly executed by the processing device 60 in a predetermined cycle. Specifically, the processor 60a in the processing device 60 reads a program stored in the memory 60b and executes the program to implement the control related to the flow. Note that the flow shown in FIG. 5 is performed at start of the engine 1.

First, in step S20, the processing device 60 acquires various kinds of information including detection values detected by the above-mentioned sensors SW1 to SW8 (as listed in FIG. 2) and the like. Typically, the processing device 60 acquires the first detected air-fuel ratio detected by the linear A/F sensor SW6, the second detected air-fuel ratio detected by the linear A/F sensor SW7, the outside air temperature detected by the outside air temperature sensor SW8, and the like. In addition, the processing device 60 also acquires the temperature of the catalyst device 51. For example, the processing device 60 estimates the catalyst temperature on the basis of heat balance and the like, taking into consideration heat generated by the engine 1 (obtained from the revolution speed and load of the engine 1), heat consumed in the exhaust passage 50 up to the catalyst device 51, reaction heat in the catalyst device 51, and the like. By comparing the catalyst temperature with the outside air temperature, it is possible to determine whether the engine 1 is at start after soaking. That is, when the catalyst temperature and the outside air temperature are approximately equal to each other at the start of the catalyst diagnosis process, it can be said that it is at start after soaking. Note that instead of estimating the catalyst temperature, the catalyst device 51 may be provided with a temperature sensor to directly detect the catalyst temperature.

Next, in step S21, the processing device 60 determines whether the linear A/F sensor SW6 is active. For example, on the basis of the magnitude of the internal resistance of the linear A/F sensor SW6 (indicating the temperature of the linear A/F sensor SW6), the processing device 60 determines the activity of the sensor. As a result of step S21, when the processing device 60 determines that the linear A/F sensor SW6 is active (step S21: Yes), the processing device 60 proceeds to step S22 and controls the fuel injection valve 18 so as to adjust the air-fuel ratio on the upstream side of the catalyst device 51 to the target air-fuel ratio. On the other hand, when the processing device 60 does not determine that the linear A/F sensor SW6 is active (step S21: No), the processing device 60 returns to step S21.

Next, in step S23, the processing device 60 determines whether the linear A/F sensor SW7 is active. For example, on the basis of the magnitude of the internal resistance of the linear A/F sensor SW7 (indicating the temperature of the linear A/F sensor SW7), the processing device 60 determines the activity of the sensor. As a result of step S23, when the processing device 60 determines that the linear A/F sensor SW7 is active (step S23: Yes), the processing device 60 proceeds to step S24 and controls the fuel injection valve 18 so as to adjust the air-fuel ratio on the downstream side of the catalyst device 51 to the target air-fuel ratio. On the other hand, when the processing device 60 does not determine that the linear A/F sensor SW7 is active (step S23: No), the processing device 60 returns to step S23.

Next, in step S25, the processing device 60 calculates the first fluctuation range for the first detected air-fuel ratio from a maximum value and a minimum value of the first detected air-fuel ratio detected within the predetermined time by the linear A/F sensor SW6 provided on the upstream side of the catalyst device 51. At the same time, the processing device 60 calculates the second fluctuation range for the second detected air-fuel ratio from a maximum value and a minimum value of the second detected air-fuel ratio detected within the predetermined time by the linear A/F sensor SW7 provided on the downstream side of the catalyst device 51. Then, the processing device 60 proceeds to step S26 and calculates, from the first fluctuation range and the second fluctuation range calculated in step S25, the fluctuation range ratio (the first fluctuation range/the second fluctuation range). Then, the processing device 60 proceeds to step S27 and performs a moving average process on the fluctuation range ratio calculated in step S26 (hereinbelow, the fluctuation range ratio used in the subsequent processes refers to the value after the moving average process).

Next, in step S28, the processing device 60 determines whether the fluctuation range ratio is stable. Here, the processing device 60 determines whether the catalyst device 51 is active by checking whether the fluctuation range ratio is stable. For example, the processing device 60 determines whether a fluctuation value of the fluctuation range ratio is less than a predetermined threshold. As a result of step S28, when the processing device 60 determines that the fluctuation range ratio is stable (step S28: Yes), the processing device 60 proceeds to step S29, and when the processing device 60 does not determine that the fluctuation range ratio is stable (step S28: No), the processing device 60 returns to step S25.

Next, in step S29, the processing device 60 determines whether the current situation is a situation in which the engine 1 has started after being soaked. In this case, the processing device 60 reads a soak time and determines whether the engine 1 has been soaked for a predetermined time or longer. This causes the catalyst diagnosis process to be performed at start after the engine 1, the catalyst device 51, and the like are sufficiently cooled. As a result of step S29, when the processing device 60 determines that the engine is at start after soaking (step S29: Yes), the processing device 60 proceeds to step S30, and when the processing device 60 does not determine that the engine is at start after soaking (step S29: No), the processing device 60 finishes the catalyst diagnosis process.

Next, in step S30, the processing device 60 determines whether the deviation between the second detected air-fuel ratio detected by the linear A/F sensor SW7 and a target value is less than a threshold. Here also, the processing device 60 determines whether the catalyst device 51 is active by checking whether the second detected air-fuel ratio is stable. As a result of step S30, when the processing device 60 determines that the deviation of the second detected air-fuel ratio is less than the threshold (step S30: Yes), the processing device 60 proceeds to step S31, and when the processing device 60 does not determine that the deviation of the second detected air-fuel ratio is less than the threshold (step S30: No), the processing device 60 finishes the catalyst diagnosis process.

Next, in step S31, the processing device 60 normalizes the fluctuation range ratio calculated up to this time. Specifically, the processing device 60 defines, in the fluctuation range ratio continuously calculated from the start of the catalyst diagnosis process, its maximum value (corresponding to the value when the temporal change in the fluctuation range ratio becomes extremely small) as 1, and expresses all the fluctuation range ratios continuously calculated in this manner in the range of 0 to 1.

Next, in step S32, the processing device 60 acquires the catalyst temperature when the normalized fluctuation range ratio reaches the predetermined value (e.g., 0.5) on the basis of the normalized fluctuation range ratio calculated in step S31 and the catalyst temperature estimated up to this time.

Next, in step S33, the processing device 60 performs deterioration determination on the catalyst device 51 on the basis of the catalyst temperature acquired in step S32. Specifically, the processing device 60 determines that the catalyst device 51 is normal when the catalyst temperature is lower than the temperature defined by the determination line G15, determines that the catalyst device 51 is at the first deterioration level when the catalyst temperature is equal to or higher than the temperature defined by the determination line G15 and lower than the temperature defined by the determination line G16, and determines that the catalyst device 51 is at the second deterioration level when the catalyst temperature is equal to or higher than the temperature defined by the determination line G16.

Next, in step S34, the processing device 60 executes control corresponding to the determination result of step S34. Specifically, when the processing device 60 determines that the catalyst device 51 is at the second deterioration level, the processing device 60 turns on the warning light 70. In addition, when the processing device 60 determines that the catalyst device 51 is at the first deterioration level, the processing device 60 controls the fuel injection valve 18 so as to cause, when a fuel cut for the engine 1 is executed later, the amount of fuel increased upon a return from the fuel cut to be smaller than when the catalyst device 51 is normal. The reason why this control is performed is as follows.

During the fuel cut, only air is supplied to the catalyst device 51, and the oxygen storage capacity (OSC) increases. When the oxygen storage capacity of the catalyst device 51 increases in this manner, the NOₓ purification performance is degraded after a return from the fuel cut. Thus, the processing device 60 temporarily increases the amount of fuel so as to reduce the oxygen storage capacity of the catalyst device 51 at a return from the fuel cut. Here, when the catalyst device 51 is normal, it is necessary to increase the amount of fuel because the oxygen storage capacity is high, but when the catalyst device 51 is deteriorated, it is not necessary to increase the amount of fuel as much as in normal condition because the oxygen storage capacity is low. For this reason, the amount of fuel increased when the engine 1 returns from the fuel cut is made smaller when the catalyst device 51 is deteriorated than when the catalyst device 51 is normal.

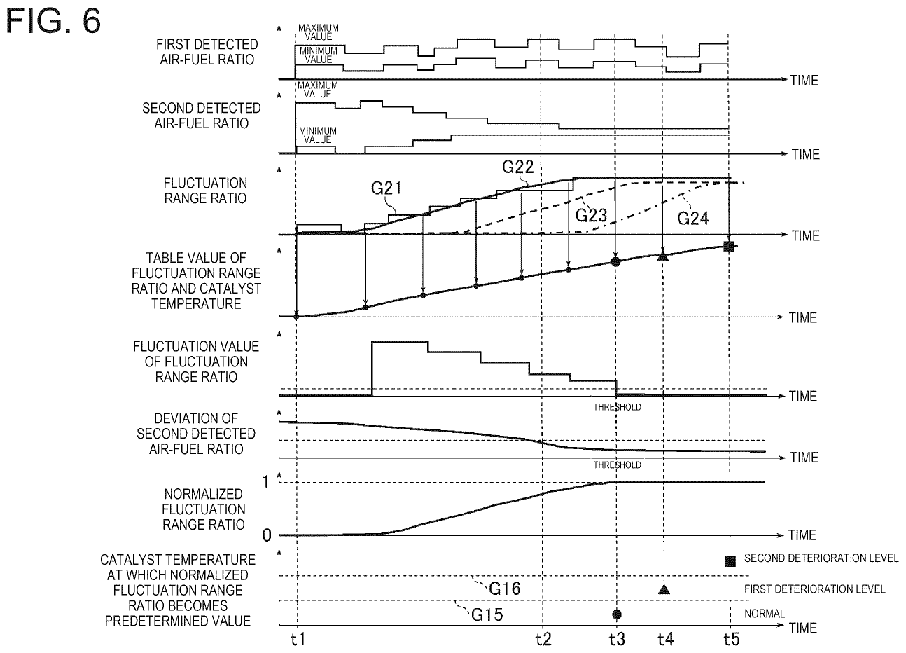

Next, a time chart of the catalyst diagnosis process performed in cold condition in the present embodiment will be described with reference to FIG. 6. FIG. 6 shows, from top to bottom, a maximum value and a minimum value of the first detected air-fuel ratio, a maximum value and a minimum value of the second detected air-fuel ratio, the fluctuation range ratio, a table value of the fluctuation range ratio and the catalyst temperature, a fluctuation value of the fluctuation range ratio, the deviation of the second detected air-fuel ratio, the normalized fluctuation range ratio, and the catalyst temperature at which the normalized fluctuation range ratio becomes the predetermined value.

Before time t1, conditions, such as an ignition of the vehicle being turned on, the engine 1 being started, the catalyst device 51 being soaked (in this case, the catalyst temperature being approximately equal to the outside air temperature), and the linear A/F sensors SW6, SW7 being active, are satisfied. Thus, the processing device 60 starts a specific process in the catalyst diagnosis process in cold condition at time t1.

Specifically, starting at time t1, the processing device 60 acquires the maximum value and the minimum value of the first detected air-fuel ratio detected by the linear A/F sensor SW6 provided on the upstream side of the catalyst device 51 and acquires the maximum value and the minimum value of the second detected air-fuel ratio detected by the linear A/F sensor SW7 provided on the downstream side of the catalyst device 51. Then, the processing device 60 calculates the first fluctuation range from the maximum value and the minimum value of the first detected air-fuel ratio and calculates the second fluctuation range from the maximum value and the minimum value of the second detected air-fuel ratio, and calculates the fluctuation range ratio (the first fluctuation range/the second fluctuation range) from these first and the second fluctuation ranges. In addition, the processing device 60 performs a moving average process on the fluctuation range ratio calculated in this manner.

In FIG. 6, graph G21 shows an example of the fluctuation range ratio before the moving average process when the catalyst device 51 is normal, and graph G22 shows an example of the fluctuation range ratio obtained by performing the moving average process on graph G21. In addition, graph G23 shows an example of the fluctuation range ratio processed by moving average when the catalyst device 51 is at the first deterioration level, and graph G24 shows an example of the fluctuation range ratio processed by moving average when the catalyst device 51 is at the second deterioration level.

The processing device 60 also estimates the temperature of the catalyst device 51 and calculates the table value of the fluctuation range ratio and the catalyst temperature, that is, associates the fluctuation range ratio and the catalyst temperature with each other using the catalyst temperature. In addition, the processing device 60 calculates the fluctuation value of the fluctuation range ratio and the deviation between the second detected air-fuel ratio and the target value to determine whether the catalyst device 51 is active. Then, at time t2, the deviation of the second detected air-fuel ratio becomes less than the threshold, and further at time t3, the fluctuation value of the fluctuation range ratio also becomes less than the threshold. After time t3, the fluctuation range ratio reaches the maximum value, so that the processing device 60 defines the maximum value of the fluctuation range ratio as 1 and expresses the fluctuation range ratio continuously calculated from the start of the catalyst diagnosis process within the range of 0 to 1, thereby calculating the normalized fluctuation range ratio. Then, the processing device 60 acquires the catalyst temperature when the normalized fluctuation range ratio reaches the predetermined value (e.g., 0.5). Note that FIG. 6 shows, for the case in which the catalyst device 51 is normal (graph G22), examples of the table value of the fluctuation range ratio and the catalyst temperature, the fluctuation value of the fluctuation range ratio, the deviation of the second detected air-fuel ratio, and the normalized fluctuation range ratio.

In the example shown in FIG. 6, when the catalyst device 51 is normal (graph G22), the processing device 60 acquires at time t3 the catalyst temperature when the normalized fluctuation range ratio reaches the predetermined value. In this case, since the acquired catalyst temperature is lower than the temperature defined by the determination line G15, the processing device 60 determines that the catalyst device 51 is normal. On the other hand, when the catalyst device 51 is at the first deterioration level (graph G23), the processing device 60 acquires at subsequent time t4 the catalyst temperature when the normalized fluctuation range ratio reaches the predetermined value. In this case, since the acquired catalyst temperature is equal to or higher than the temperature defined by the determination line G15 and lower than the temperature defined by the determination line G16, the processing device 60 determines that the catalyst device 51 is at the first deterioration level. In addition, when the catalyst device 51 is at the second deterioration level (graph G24), the processing device 60 acquires at subsequent time t5 the catalyst temperature when the normalized fluctuation range ratio reaches the predetermined value. In this case, since the acquired catalyst temperature is equal to or higher than the temperature defined by the determination line G16, the processing device 60 determines that the catalyst device 51 is at the second deterioration level.

### (Process in Warm Condition)

Next, the catalyst diagnosis process that is performed after the start of the engine 1, that is, in warm condition (assuming that the catalyst device 51 is in an active state) in the present embodiment will be described. In the present embodiment, in warm condition of the engine 1, when the fuel cut for the engine 1 is being executed, the processing device 60 calculates an oxygen storage capacity of the catalyst device 51 on the basis of the first detected air-fuel ratio detected by a first linear A/F sensor SW6 and the second detected air-fuel ratio detected by a second linear A/F sensor SW7, and diagnoses the catalyst device 51 on the basis of this oxygen storage capacity.

When the catalyst device 51 is diagnosed on the basis of the oxygen storage capacity, it can be said that it is desirable for the catalyst device 51 to be in an oxygen-saturated state in order to accurately perform the diagnosis. The oxygen storage capacity changes in accordance with the degree of deterioration of the catalyst device 51, but in an oxygen-saturated state, since the oxygen storage capacity of the catalyst device 51 becomes almost maximum, the degree of deterioration of the catalyst device 51 is clearly reflected in the magnitude of the oxygen storage capacity, and the diagnosis can be accurately performed. On the other hand, during the fuel cut for the engine 1, since, basically, only air is supplied to the catalyst device 51, the catalyst device 51 can be promptly brought into an oxygen-saturated state. For such a reason, in the present embodiment, the catalyst device 51 is diagnosed during the fuel cut.

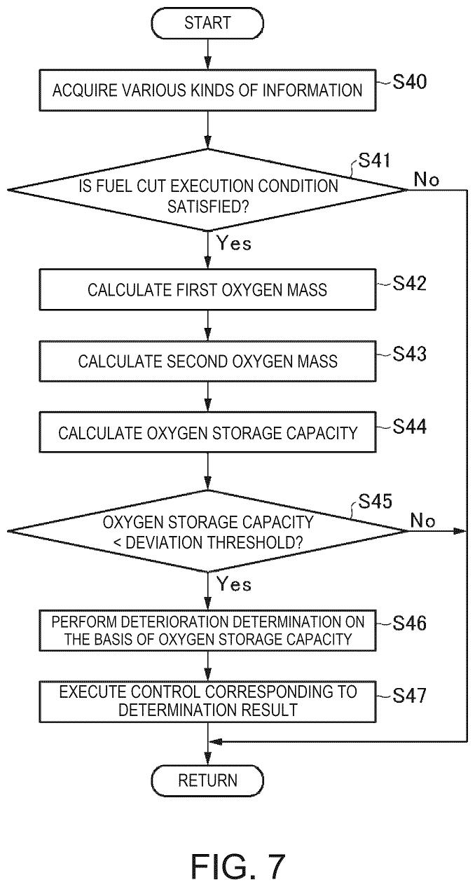

Next, the catalyst diagnosis process that is performed in warm condition in the present embodiment will be described with reference to FIG. 7. This flow is repeatedly executed by the processing device 60 in a predetermined cycle. Specifically, the processor 60a in the processing device 60 reads a program stored in the memory 60b and executes the program to implement the control related to the flow. Note that the flow shown in FIG. 7 is performed when control for setting the air-fuel ratio on the downstream side of the catalyst device 51 to the target air-fuel ratio is being executed.

First, in step S40, the processing device 60 acquires various kinds of information including detection values detected by the above-mentioned sensors SW1 to SW8 and the like (as listed in FIG. 2). Typically, the processing device 60 acquires the first detected air-fuel ratio detected by the linear A/F sensor SW6, the second detected air-fuel ratio detected by the linear A/F sensor SW7, the flow rate of intake air detected by the air flow sensor SW1, and the like. In addition, the processing device 60 also acquires the temperature of the catalyst device 51. For example, the processing device 60 estimates the catalyst temperature. Note that instead of estimating the catalyst temperature, the catalyst device 51 may be provided with a temperature sensor to directly detect the catalyst temperature.

Next, in step S41, the processing device 60 determines whether a fuel cut execution condition is satisfied. For example, the processing device 60 determines that the fuel cut execution condition is satisfied when the accelerator opening degree detected by the accelerator opening degree sensor SW5 is zero and the engine revolution speed detected by the crank angle sensor SW4 is equal to or higher than a predetermined value (step S41: Yes). In this case, the processing device 60 proceeds to step S42. On the other hand, when the processing device 60 does not determine that the fuel cut execution condition is satisfied (step S41: No), the processing device 60 finishes the catalyst diagnosis process.

Next, in step S42, the processing device 60 calculates an oxygen mass on the upstream side of the catalyst device 51 (hereinbelow, referred to as a “first oxygen mass”) on the basis of the first detected air-fuel ratio detected by the linear A/F sensor SW6. Then, in step S43, the processing device 60 calculates an oxygen mass on the downstream side of the catalyst device 51 (hereinbelow, referred to as a “second oxygen mass”) on the basis of the second detected air-fuel ratio detected by the linear A/F sensor SW7. Then, in step S44, the processing device 60 calculates the oxygen storage capacity of the catalyst device 51 by subtracting the second oxygen mass calculated in step S43 from the first oxygen mass calculated in step S42.

Next, in step S45, the processing device 60 determines whether the oxygen storage capacity calculated in step S44 is less than a predetermined deviation threshold. Here, the processing device 60 determines whether the oxygen storage capacity is stable, that is, whether the fluctuation of the oxygen storage capacity is small. As a result of step S45, when the processing device 60 determines that the oxygen storage capacity is less than the deviation threshold (step S45: Yes), the processing device 60 proceeds to step S46. On the other hand, when the processing device 60 does not determine that the oxygen storage capacity is less than the deviation threshold (step S45: No), the processing device 60 finishes the catalyst diagnosis process.

Next, in step S46, the processing device 60 performs deterioration determination on the catalyst device 51 on the basis of the calculated oxygen storage capacity. Specifically, the processing device 60 compares the oxygen storage capacity with a predetermined threshold to perform the deterioration determination on the catalyst device 51. Specifically, the processing device 60 determines that the catalyst device 51 is normal when the oxygen storage capacity is equal to or higher than a first threshold, determines that the catalyst device 51 is at the first deterioration level when the oxygen storage capacity is less than the first threshold and equal to or higher than a second threshold, and determines that the catalyst device 51 is at the second deterioration level when the oxygen storage capacity is less than the second threshold. Note that the processing device 60 sets such thresholds on the basis of the catalyst temperature.

Next, in step S47, the processing device 60 executes control corresponding to the result of determination in step S46. Specifically, when the processing device 60 determines that the catalyst device 51 is at the second deterioration level, the processing device 60 turns on the warning light 70. In addition, when the processing device 60 determines that the catalyst device 51 is at the first deterioration level, the processing device 60 controls the fuel injection valve 18 so as to make the amount of fuel increased when the engine 1 returns from the fuel cut smaller than when the catalyst device 51 is normal.

### Action and Effects

Next, the action and effects of the engine catalyst diagnosis apparatus 100 according to the present embodiment will be described.

In the present embodiment, the engine catalyst diagnosis apparatus 100 includes the exhaust passage 50 for discharging exhaust gas from the combustion chamber 17 of the engine 1, the catalyst device 51 provided on the exhaust passage 50 for purifying the exhaust gas, the linear A/F sensor SW7 that is provided on the exhaust passage 50 downstream of the catalyst device 51 and is configured to detect the air-fuel ratio of the exhaust gas, and the processing device 60 configured to diagnose the catalyst device 51 on the basis of at least the air-fuel ratio detected by the linear A/F sensor SW7, and the processing device 60 is configured to, at start of the engine 1 after soaking, acquire the temperature of the catalyst device 51, calculate the fluctuation range of the air-fuel ratio detected by the linear A/F sensor SW7 within the predetermined time, and diagnose the catalyst device 51 on the basis of the relationship between the fluctuation range and the catalyst temperature.

In the present embodiment as such, in cold condition in which the difference corresponding to the degree of deterioration of the catalyst device 51 becomes noticeable, the processing device 60 diagnoses the catalyst device 51. In particular, since the catalyst temperature at which the catalyst device 51 becomes active changes in accordance with the degree of deterioration of the catalyst device 51, the processing device 60 uses the catalyst temperature to diagnose the catalyst device 51. In addition, the processing device 60 uses the fluctuations of the air-fuel ratio on the downstream side of the catalyst device 51 to determine the active state of the catalyst device 51. This is because although the air-fuel ratio on the downstream side of the catalyst device 51 fluctuates relatively largely when the catalyst device 51 is not active, as the catalyst device 51 becomes active, the consumption of oxygen in the catalyst device 51 increases, which reduces fluctuations of the air-fuel ratio on the downstream side of the catalyst device 51, and thus, the active state of the catalyst device 51 can be appropriately determined on the basis of such fluctuations of the air-fuel ratio. From the above, in the present embodiment, when in cold condition, the processing device 60 diagnoses the catalyst device 51 on the basis of the relationship between the fluctuation range of the air-fuel ratio on the downstream side of the catalyst device 51 and the catalyst temperature. This makes it possible to significantly improve the diagnostic accuracy of the catalyst device 51.

In addition, in the present embodiment, the processing device 60 determines the degree of activity of the catalyst device 51 on the basis of the fluctuation range, and diagnoses the catalyst device 51 on the basis of the catalyst temperature when the catalyst device 51 reaches the predetermined degree of activity. Accordingly, by using the catalyst temperature when the catalyst device 51 reaches the predetermined degree of activity, it is possible to appropriately diagnose the catalyst device 51.

In addition, in the present embodiment, the processing device 60 diagnoses deterioration of the catalyst device 51 when the acquired catalyst temperature is equal to or higher than the predetermined temperature. In this case, since the rise of the exhaust gas purification performance of the catalyst device 51 is slow, the processing device 60 diagnoses the deterioration of the catalyst device 51. This makes it possible to appropriately diagnose the catalyst device 51.

In addition, in the present embodiment, the engine catalyst diagnosis apparatus 100 further includes the linear A/F sensor SW6 that is provided on the exhaust passage 50 upstream of the catalyst device 51 and is configured to detect the air-fuel ratio of the exhaust gas (first detected air-fuel ratio), and the processing device 60 calculates the first fluctuation range of the first detected air-fuel ratio detected by the linear A/F sensor SW6 within the predetermined time together with the second fluctuation range of the second detected air-fuel ratio detected by the linear A/F sensor SW7 within the predetermined time, calculates the fluctuation range ratio that is the ratio of the first fluctuation range to the second fluctuation range, and determines the degree of activity of the catalyst device 51 on the basis of the fluctuation range ratio. Since the first fluctuation range on the upstream side of the catalyst device 51 is not affected by the exhaust gas purification performance of the catalyst device 51 and thus stable, in the present embodiment, the magnitude of the second fluctuation range on the downstream side of the catalyst device 51 is evaluated using such a first fluctuation range as a criterion (reference). This makes it possible to ensure the diagnostic accuracy of the catalyst device 51.

In addition, in the present embodiment, the processing device 60 normalizes the fluctuation range ratio, determines that the catalyst device 51 has reached the predetermined degree of activity when the normalized fluctuation range ratio reaches the predetermined value, and diagnoses the catalyst device 51 on the basis of the catalyst temperature at this time. Since the fluctuation range ratio has no unit and changes in accordance with various factors such as the amount of precious metal, the durability, and the deteriorated state of the catalyst device 51, to eliminate the influence of these factors and ensure versatility, the process is performed using the value obtained by normalizing the fluctuation range ratio (the normalized fluctuation range ratio). This makes it possible to effectively ensure the diagnostic accuracy of the catalyst device 51.

In addition, in the present embodiment, when the fuel cut for the engine 1 is being executed after start of the engine 1, the processing device 60 calculates the oxygen storage capacity of the catalyst device 51 on the basis of the first detected air-fuel ratio detected by the first linear A/F sensor SW6 and the second detected air-fuel ratio detected by the second linear A/F sensor SW7, and further diagnoses the catalyst device 51 on the basis of the oxygen storage capacity. During the fuel cut for the engine 1, since only air is supplied to the catalyst device 51, the catalyst device 51 tends to assume an oxygen-saturated state. By diagnosing the catalyst device 51 on the basis of the oxygen storage capacity in such an oxygen-saturated state, it is possible to accurately diagnose the catalyst device 51.

In addition, in the present embodiment, the processing device 60 controls the fuel injection valve 18 so as to increase the amount of fuel supplied to the combustion chamber 17 when the engine 1 returns from the fuel cut, and makes an amount by which the amount of fuel is increased smaller when it is diagnosed that the catalyst device 51 is deteriorated than when it is not diagnosed that the catalyst device 51 is deteriorated. This makes it possible to reduce an unnecessary increase in the amount of fuel and improve fuel efficiency.

In addition, in the present embodiment, the processing device 60 performs control to turn on the warning light 70 when it is diagnosed that the catalyst device 51 is deteriorated. This makes it possible to appropriately notify the occupant of the deterioration of the catalyst device 51 and urge the occupant, for example, to replace the catalyst device 51.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### REFERENCE CHARACTER LIST

1 engine
13 cylinder
17 combustion chamber
18 fuel injection valve
19 spark plug
40 intake passage
50 exhaust passage
51, 52 catalyst device
60 processing device
70 warning light
100 engine catalyst diagnosis apparatus
SW6, SW7 linear A/F sensor

What is claimed is:

1. An engine catalyst diagnosis apparatus, comprising:
an exhaust passage for discharging exhaust gas from a combustion chamber of an engine;
a catalyst device provided on the exhaust passage for purifying the exhaust gas;
a linear air-fuel (A/F) sensor that is provided on the exhaust passage downstream of the catalyst device and is configured to detect an air-fuel ratio of the exhaust gas; and
a processing device configured to diagnose the catalyst device on the basis of at least the air-fuel ratio detected by the linear A/F sensor, wherein the processing device is configured to, at start of the engine after soaking:
acquire a temperature of the catalyst device,
calculate a fluctuation range of the air-fuel ratio detected by the linear A/F sensor within a predetermined time, and
diagnose the catalyst device on the basis of a relationship between the fluctuation range and the temperature of the catalyst device.

2. The engine catalyst diagnosis apparatus according to claim 1, wherein the processing device is configured to:
determine a degree of activity of the catalyst device on the basis of the fluctuation range, and
acquire the temperature of the catalyst device when the catalyst device reaches a predetermined degree of activity on the basis of a result of determining the degree of activity, and diagnose the catalyst device on the basis of the temperature.

3. The engine catalyst diagnosis apparatus according to claim 2, wherein the processing device diagnoses deterioration of the catalyst device when the temperature of the catalyst device, when the catalyst device reaches the predetermined degree of activity, is equal to or higher than a predetermined temperature.

4. The engine catalyst diagnosis apparatus according to claim 3, further comprising, when the linear A/F sensor is defined as a second linear A/F sensor, the air-fuel ratio detected by the second linear A/F sensor is defined as a second air-fuel ratio, and the fluctuation range of the second air-fuel ratio detected by the second linear A/F sensor within the predetermined time is defined as a second fluctuation range, a first linear A/F sensor that is provided on the exhaust passage upstream of the catalyst device and is configured to detect a first air-fuel ratio of the exhaust gas, wherein
the processing device is configured to, at start in the engine after soaking:
calculate a first fluctuation range of the first air-fuel ratio detected by the first linear A/F sensor within the predetermined time together with the second fluctuation range,
calculate a fluctuation range ratio that is a ratio of the first fluctuation range to the second fluctuation range, and
determine the degree of activity of the catalyst device on the basis of the fluctuation range ratio.

5. The engine catalyst diagnosis apparatus according to claim 4, wherein the processing device normalizes the fluctuation range ratio, determines that the catalyst device has reached the predetermined degree of activity when the normalized fluctuation range ratio reaches a predetermined value, and diagnoses the catalyst device on the basis of the temperature of the catalyst device at this time.

6. The engine catalyst diagnosis apparatus according to claim 1, further comprising, when the linear A/F sensor is defined as a second linear A/F sensor and the air-fuel ratio detected by the second linear A/F sensor is defined as a second air-fuel ratio, a first linear A/F sensor that is provided on the exhaust passage upstream of the catalyst device and is configured to detect a first air-fuel ratio of the exhaust gas, wherein
the processing device is configured to, when a fuel cut for the engine is being executed after start of the engine:
calculate an oxygen storage capacity of the catalyst device on the basis of the first air-fuel ratio detected by the first linear A/F sensor and the second air-fuel ratio detected by the second linear A/F sensor, and
further diagnose the catalyst device on the basis of the oxygen storage capacity.

7. The engine catalyst diagnosis apparatus according to claim 1, further comprising a fuel injection valve for supplying fuel to the combustion chamber, wherein
the processing device is configured to:
control the fuel injection valve so as to increase an amount of fuel supplied to the combustion chamber when the engine returns from a fuel cut, and
make an amount by which the amount of fuel is increased smaller when deterioration of the catalyst device is diagnosed than when it is not diagnosed.

8. The engine catalyst diagnosis apparatus according to claim 1, further comprising a warning light for notifying an occupant of a vehicle of an abnormality, wherein
the processing device is configured to perform control to turn on the warning light when deterioration of the catalyst device is diagnosed.

9. The engine catalyst diagnosis apparatus according to claim 2, further comprising, when the linear A/F sensor is defined as a second linear A/F sensor and the air-fuel ratio detected by the second linear A/F sensor is defined as a second air-fuel ratio, a first linear A/F sensor that is provided on the exhaust passage upstream of the catalyst device and is configured to detect a first air-fuel ratio of the exhaust gas, wherein
the processing device is configured to, when a fuel cut for the engine is being executed after start of the engine:
calculate an oxygen storage capacity of the catalyst device on the basis of the first air-fuel ratio detected by the first linear A/F sensor and the second air-fuel ratio detected by the second linear A/F sensor, and
further diagnose the catalyst device on the basis of the oxygen storage capacity.

10. The engine catalyst diagnosis apparatus according to claim 2, further comprising a fuel injection valve for supplying fuel to the combustion chamber, wherein
the processing device is configured to:
control the fuel injection valve so as to increase an amount of fuel supplied to the combustion chamber when the engine returns from a fuel cut, and
make an amount by which the amount of fuel is increased smaller when deterioration of the catalyst device is diagnosed than when it is not diagnosed.

11. The engine catalyst diagnosis apparatus according to claim 2, further comprising a warning light for notifying an occupant of a vehicle of an abnormality, wherein
the processing device is configured to perform control to turn on the warning light when deterioration of the catalyst device is diagnosed.

12. The engine catalyst diagnosis apparatus according to claim 3, further comprising, when the linear A/F sensor is defined as a second linear A/F sensor and the air-fuel ratio detected by the second linear A/F sensor is defined as a second air-fuel ratio, a first linear A/F sensor that is provided on the exhaust passage upstream of the catalyst device and is configured to detect a first air-fuel ratio of the exhaust gas, wherein
the processing device is configured to, when a fuel cut for the engine is being executed after start of the engine:
calculate an oxygen storage capacity of the catalyst device on the basis of the first air-fuel ratio detected by the first linear A/F sensor and the second air-fuel ratio detected by the second linear A/F sensor, and
further diagnose the catalyst device on the basis of the oxygen storage capacity.

13. The engine catalyst diagnosis apparatus according to claim 3, further comprising a fuel injection valve for supplying fuel to the combustion chamber, wherein
the processing device is configured to:
control the fuel injection valve so as to increase an amount of fuel supplied to the combustion chamber when the engine returns from a fuel cut, and
make an amount by which the amount of fuel is increased smaller the deterioration of the catalyst device is diagnosed than when it is not diagnosed.

14. The engine catalyst diagnosis apparatus according to claim 3, further comprising a warning light for notifying an occupant of a vehicle of an abnormality, wherein
the processing device is configured to perform control to turn on the warning light when the deterioration of the catalyst device is diagnosed.

15. The engine catalyst diagnosis apparatus according to claim 4, further comprising, when the linear A/F sensor is defined as the second linear A/F sensor and the air-fuel ratio detected by the second linear A/F sensor is defined as the second air-fuel ratio, the first linear A/F sensor that is provided on the exhaust passage upstream of the catalyst device and is configured to detect the first air-fuel ratio of the exhaust gas, wherein
the processing device is configured to, when a fuel cut for the engine is being executed after start of the engine:
calculate an oxygen storage capacity of the catalyst device on the basis of the first air-fuel ratio detected by the first linear A/F sensor and the second air-fuel ratio detected by the second linear A/F sensor, and
further diagnose the catalyst device on the basis of the oxygen storage capacity.

16. The engine catalyst diagnosis apparatus according to claim 4, further comprising a fuel injection valve for supplying fuel to the combustion chamber, wherein
the processing device is configured to:
control the fuel injection valve so as to increase an amount of fuel supplied to the combustion chamber when the engine returns from a fuel cut, and
make an amount by which the amount of fuel is increased smaller when deterioration of the catalyst device is diagnosed than when it is not diagnosed.

17. The engine catalyst diagnosis apparatus according to claim 4, further comprising a warning light for notifying an occupant of a vehicle of an abnormality, wherein
the processing device is configured to perform control to turn on the warning light when deterioration of the catalyst device is diagnosed.

18. The engine catalyst diagnosis apparatus according to claim 5, further comprising, when the linear A/F sensor is defined as the second linear A/F sensor and the air-fuel ratio detected by the second linear A/F sensor is defined as the second air-fuel ratio, the first linear A/F sensor that is provided on the exhaust passage upstream of the catalyst device and is configured to detect the first air-fuel ratio of the exhaust gas, wherein
the processing device is configured to, when a fuel cut for the engine is being executed after start of the engine:
calculate an oxygen storage capacity of the catalyst device on the basis of the first air-fuel ratio detected by the first linear A/F sensor and the second air-fuel ratio detected by the second linear A/F sensor, and
further diagnose the catalyst device on the basis of the oxygen storage capacity.

19. The engine catalyst diagnosis apparatus according to claim 5, further comprising a fuel injection valve for supplying fuel to the combustion chamber, wherein
the processing device is configured to:
control the fuel injection valve so as to increase an amount of fuel supplied to the combustion chamber when the engine returns from a fuel cut, and
make an amount by which the amount of fuel is increased smaller when deterioration of the catalyst device is diagnosed than when it is not diagnosed.

20. The engine catalyst diagnosis apparatus according to claim 5, further comprising a warning light for notifying an occupant of a vehicle of an abnormality, wherein
the processing device is configured to perform control to turn on the warning light when deterioration of the catalyst device is diagnosed.
